(19) United States
(12) Patent Application Publication
(10) Pub. No.: US 2008/0270672 A1
(43) Pub. Date: Oct. 30, 2008

(54) Disk drive device and method for accessing disk thereof

(76) Inventor: Tsuguaki Kowa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/148,165

(22) Filed: Apr. 16, 2008

(30) Foreign Application Priority Data
Apr. 25, 2007 (JP) 2007-115986

(51) Int. Cl. G06F 12/00

(52) U.S. Cl. 711/4; 711/E12.001

(57) ABSTRACT

Embodiments of the present invention help to improve accuracy in data and maintain data rate in a disk drive device which sends data at a reassignment source address to a host in response to a specific command. According to one embodiment, a hard disk drive (HDD) performs data write operations to a reassignment source data sector in addition to a reassignment destination source data sector if a reassigned data sector is present. Writing data to the reassignment source data sector improves accuracy in data to be transferred in a continuous read. The number of execution steps registered in an error recovery procedure (ERP) table in a write operation to the reassignment source data sector is smaller than the number of execution steps registered in an ERP table to the reassignment destination data sector.

### CROSS-REFERENCE TO RELATED APPLICATION

The instant nonprovisional patent application claims priority to Japanese Patent Application No. 2007-115986 filed Apr. 25, 2007 and which is incorporated by reference in its entirety herein for all purposes.

### BACKGROUND OF THE INVENTION

Disk drive devices using various kinds of disks, such as an optical disk, a magneto-optical disk, and a flexible magnetic disk, have been known in the art. In particular, a hard disk drive (HDD) has been widely used as a storage device of a computer and has been one of indispensable storage devices for current computer systems. Moreover, the HDD has found widespread application such as a removable memory used in a moving image recording/reproducing apparatus, a car navigation system, a cellular phone, or a digital camera, as well as the computer, due to its outstanding characteristics.

Magnetic disks used in the HDD have a plurality of data tracks formed concentrically. Each data track has a plurality of data sectors recorded thereon. On the magnetic disk, a plurality of servo data are discretely recorded in the circumferential direction. A head element portion of a head slider supported by a swinging actuator accesses a desired data sector according to address information of the servo data, which allows data writing to and data retrieving from a data sector.

If a data sector on the recording surface is a defective sector and data writing thereto or data retrieving therefrom cannot be performed, the sector is reassigned to another sector. That is, if a host accesses (reads from or writes to) the defective sector which is the reassignment source sector, the HDD accesses the reassignment destination sector corresponding to the defective sector. This leads to inhibition of using a defective sector within the HDD with no necessity of address management by the host.

With expansion of use range of PC applications and HDDs in recent years, opportunities for storing AV data in HDDs have been increasing. Hence, a stream command is defined corresponding to continuous data such as AV data. In reproducing AV data, data continuity (data transfer rate) has a higher priority than a marginal data error (accuracy). Therefore, an option is prepared that does not start an error recovery, but accesses the next sector even if an error has occurred during data retrieval or data write. This is referred to as continuous read or continuous write.

When the host requests accesses to continuous sectors as in accesses in AV data, an access to the reassignment destination address needs more time than an access to the reassignment source address because the reassignment destination sector is located at a position away from the reassignment source sector. Therefore, a technique has been known that accesses the reassignment source sector instead of the reassignment destination sector in the accesses in response to an AV command even if there is a reassigned sector (for example, refer to Japanese Patent Publication No. 2004-70979 “Patent Document 1”). This allows the AV data to be transferred at a required constant rate.

As in the above conventional technique, retrieving data at the reassignment source sector can maintain the transfer rate and continuity of the AV data. However, if a data sector has been reassigned, new data is written in the reassignment destination sector and data in the reassignment source sector will never be updated. This results in that the HDD always sends the host incorrect data in response to the AV command. Even in a mode where the transfer rate has higher priority than the accuracy in data, it is preferable to transfer more accurate data to the host. If a plurality of data sectors designated by the AV command include many reassigned data sectors, accuracy in data to be transferred to the host will be significantly impaired.

### BRIEF SUMMARY OF THE INVENTION

Embodiments of the present invention help to improve accuracy in data and maintain data rate in a disk drive device which sends data at a reassignment source address to a host in response to a specific command. According to the embodiment of FIG. 1, a hard disk drive (HDD) 1 performs data write operations to a reassignment source data sector in addition to a reassignment destination source data sector if a reassigned data sector is present. Writing data to the reassignment source data sector improves accuracy in data to be transferred in a continuous read. The number of execution steps registered in an error recovery procedure (ERP) table in a write operation to the reassignment source data sector is smaller than the number of execution steps registered in an ERP table to the reassignment destination data sector.

### BRIEF DESCRIPTION OF THE DRAWINGS

FIG. 1 is a block diagram schematically showing the entire configuration of an HDD according to the present embodiment.

FIG. 2 is a flowchart depicting operation steps of the continuous read according to one embodiment.

FIG. 3 is a block diagram schematically illustrating logical components relating to the data write operation according to one embodiment.

FIG. 4 is a flowchart depicting operation steps of changing the ERP table in write operations to the reassignment destination data sector and the reassignment source data sector according to one embodiment.

FIG. 5 is a flowchart depicting operation steps in case of omitting the error recovery in a write operation to the reassignment source data sector according to one embodiment.

FIG. 6 shows an example of the reassignment defect map according to one embodiment.

FIG. 7 is a flowchart depicting operation steps of determination whether or not a write operation to the reassignment source data sector should be performed depending on the reason for reassignment according to one embodiment.

FIG. 8 is a flowchart depicting operation steps of selecting the ERP table depending on the reason for reassignment in a write operation to the reassignment source data sector according to one embodiment.

FIG. 9 is a flowchart depicting operation steps of determination whether or not a write operation to the reassignment source data sector should be performed depending on the number of reassignment source data sectors in the address designated by a command according to one embodiment.

FIG. 10 is a flowchart depicting operation steps of selecting the ERP table depending on the number of reassignment data sectors in the designated address by a command in the write operation to the reassignment source data sector according to one embodiment.

FIG. 11 is a flowchart depicting operation steps of selecting either the reassignment destination or the reassignment source depending on the number of reassignment data sectors in the address designated by the command and performing a data retrieval operation in a continuous read operation according to one embodiment.

### DETAILED DESCRIPTION OF THE INVENTION

Embodiments of the present invention relate to a disk drive device and a method for accessing a disk thereof, and more particularly to control in a disk drive device for sending reassignment source address data to a host in response to a specific read command.

An aspect of embodiments of the present invention is a method for accessing a disk in a disk drive device. This method performs a data write operation to a reassignment source address and a reassignment destination address corresponding to the reassignment source address in response to a write command to the reassignment source address. It sends data at the reassignment destination address in response to a normal read command, and also sends data at the reassignment source address in response to a predetermined read command. Performing a data write operation to a reassignment source address improves accuracy in data. This aspect includes a method for performing a data write operation only in the case that predetermined conditions are satisfied. The data write operation includes the case that the operation does not write data on the disk because of errors or the like.

In one example, if an error occurs in the data write operation to the reassignment source address, the method omits an error recovery and ends the data write operation to the reassignment source address. The omission of the error recovery results in preventing performance degradation.

In one example, the maximum number of steps for an error recovery corresponding to the data write operation to the reassignment source address is smaller than the maximum number of steps for an error recovery corresponding to the data write operation to the reassignment destination address. This achieves accuracy in data and good performance.

In one example, the method changes the data write operation to the reassignment source address depending on a reason for reassignment of the reassignment source address. Furthermore, if the reason for reassignment is a write error, it is preferable that the method omits an error recovery in the data write operation to the reassignment source address or sets the maximum number of steps for the error recovery to be smaller than the maximum number of steps in a case that the reason for reassignment is a read error. This achieves accuracy in data and good performance.

In one example, the method determines whether or not the data write operation to the reassignment source address should be executed depending on the kind of the write command. This achieves accuracy in data and good performance.

In one example, the write command to the reassignment source address includes a plurality of addresses, and the method determines whether or not the data write operation to the reassignment source address should be executed or changes the maximum number of steps for the error recovery depending on the number of the reassignment source addresses included in the plurality of addresses. This achieves accuracy in data and good performance.

A disk drive device according to another aspect of embodiments of the present invention comprises a head for accessing a disk, a moving mechanism for moving the head above the disk, and a controller for sending data at a reassignment destination address retrieved with the head in response to a normal read command and sending data at a reassignment source address retrieved with the head in response to a predetermined read command. The controller performs data write operations to the reassignment destination address corresponding to the reassignment source address and the reassignment source address in response to a write command to the reassignment source address. Performing a data write operation to the reassignment source address can improve accuracy in data. This aspect includes a device for performing a data write operation only in the case that predetermined conditions are satisfied. The data write operation includes the case that the operation does not write data on the disk because of errors or the like.

A disk drive device according to yet another aspect of embodiments of the present invention comprises a head for accessing a disk, a moving mechanism for moving the head, and a controller for controlling the moving mechanism. The controller retrieves data at a reassignment destination address using the head in response to a normal read command, and further determines whether to retrieve data at a reassignment source address or to retrieve data at a reassignment destination address based on the number of reassignment source addresses included in the addresses designated by a predetermined read command. Determining whether to retrieve data at a reassignment source address or to retrieve data at a reassignment destination address based on the number of reassignment source addresses included in the addresses designated by a predetermined read command achieves accuracy in data and good performance.

In one example, the number of reassignment source addresses is the maximum number of continuous reassignment source addresses in the designated addresses, and the controller retrieves data at the reassignment destination address using the head if the maximum number of the continuous reassignment source addresses exceeds a reference number. Or, the number of reassignment source addresses is a total number of the reassignment source addresses included in the designated addresses, and the controller retrieves data at the reassignment destination address using the head if the total number exceeds a reference number. This achieves more appropriate determination.

Embodiments of the present invention can maintain a necessary data rate and improve the accuracy in data in a disk drive device which sends a host data at a reassignment source address in response to a specific command.

Hereinafter, particular embodiments to which the present invention has been applied will be described. For clarity of explanation, the following description and the accompanying drawings contain omissions and simplifications as appropriate. Throughout the drawings, like components are denoted by like reference numerals, and their repetitive description is omitted if not necessary for the sake of clarity. Hereinbelow, embodiments of the present invention will be described by way of example of a hard disk drive (HDD) as an example of a disk drive device. If an address designated by a read command contains a reassignment source data sector, the HDD according to one embodiment accesses a reassignment destination data sector in response to a normal read command and accesses a reassignment source data sector instead of the reassignment destination sector in response to a specific read command.

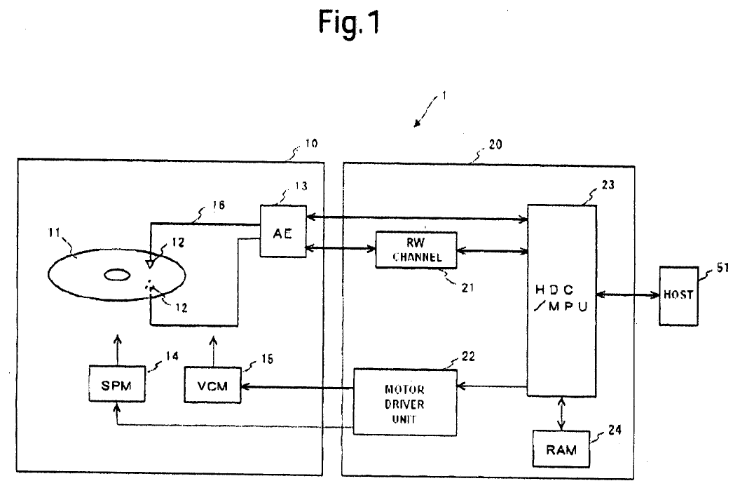

First, an entire configuration of an HDD is outlined. FIG. 1 is a block diagram schematically showing the entire configuration of an HDD 1. The HDD 1 includes a circuit board 20 fixed outside of an enclosure 10. On the circuit board 20, circuits such as a read-write channel (RW channel) 21, a motor driver unit 22, an integrated circuit (HDC/MPU) 23 of a hard disk controller (HDC) and an MPU, and an RAM 24 of a semiconductor memory, are implemented. In the enclosure 10, a spindle motor (SPM) 14 rotates a magnetic disk 11 at a specific angular rate. The magnetic disk 11 is a disk for storing data. The motor driver unit 22 drives the SPM 14 in accordance with control data from the HDC/MPU 23.

Each head slider 12 includes a slider flying over the magnetic disk and a head element portion which is fixed to the slider and converts magnetic signals and electric signals (retrieves and writes data). Each head slider 12 is fixed to a tip end of an actuator 16. The actuator 16, which is coupled to the voice coil motor (VCM) 15, pivots about a pivotal shaft to move the head sliders 12 above the magnetic disk 11 in its radial direction. The motor driver unit 22 drives the VCM 15 in accordance with control data from the HDC/MPU 23. An arm electronics (AE) 13 selects a head slider 12 to access (read from or write to) the magnetic disk 11 from a plurality of head sliders 12 in accordance with control data from the HDC/MPU 23 and amplifies read/write signals.

The RW channel 21, in a read operation, extracts servo data and user data from the read signals obtained from the AE 13 to perform a decoding process. The decoded data are supplied to the HDC/MPU 23. In a write operation, the RW channel 21 code-modulates write data supplied from the HDC/MPU 23 and further converts the code-modulated data into write signals to supply them to the AE 13. In the HDC/MPU 23, the HDC is a logic circuit and the MPU operates in accordance with firmware loaded in the RAM 24. With starting up of the HDD 1, data required for control and data processing is loaded from the magnetic disk 11 or a ROM (not shown) onto the RAM 24. The HDC/MPU 23 is an example of a controller and performs entire control of the HDD 1 in addition to necessary processes concerning data processing such as head positioning control, interface control, and defect management.

The HDC/MPU 23 transmits read data from the magnetic disk 11 obtained from the RW channel 21 to the host 51. The read data from the magnetic disk 11 is temporarily stored in a read buffer in the RAM 24 before transferred to the host 51 via the HDC/MPU 23. The write data from the host 51 is temporarily stored in a write buffer in the RAM 24 via the HDC/MPU 23 before transferred to the magnetic disk 11 via the HDC/MPU 23 at a specific timing. The HDC/MPU 23 according to one embodiment particularly controls data rewrite operation in accordance with the number of data write operations to the magnetic disk 11.

Hereinafter, detailed explanation will be given on control for the access to the magnetic disk in the HDD 1 according to one embodiment. In one embodiment, the “access” is a generic concept of read from and write to the magnetic disk 11. The HDD 1 of the present embodiment can handle a stream command for AV data and the like. If the host 51 instructs a continuous access for a stream read command, the HDD 1 transfers data to the host 51 ignoring an ECC error. Further, the HDD 1 of the present embodiment reads a data sector at the reassignment source address instead of the data sector at the reassignment destination address in response to the stream read command for which a continuous access is ordered. In the present specification, this function of the continuous read is referred to as “read continuous”.

The host 51, for example, enables the read continuous with a field within the stream read command. The HDD 1 reads the reassignment source data sector instead of the reassignment destination data sector in the address designated by the stream read command.

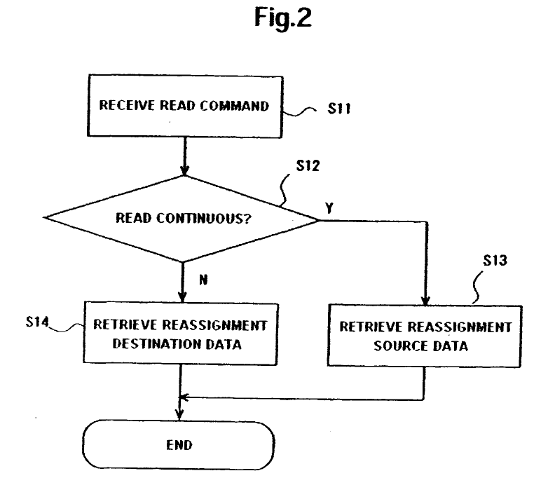

Specifically, as shown in a flowchart of FIG. 2, if the HDC/MPU 23 receives a read command from the host (S11), it determines whether or not the received read command is a command ordering the read continuous (S12). If the received read command is a stream command and the read continuous function is enabled by a setting command from the host 51 or the read command (Y in S12), the HDC/MPU 23 performs a read continuous operation. Specifically, the HDC/MPU 23 ignores an ECC error in a data retrieval operation from the magnetic disk 11, and with regard to the reassigned data sector, reads a reassignment source data sector instead of a reassignment destination data sector to transfer the data to the host 51 (S13).

If the received read command is not a stream read command or the read continuous has been disabled (N in S12), the HDC/MPU 23 retrieves data from the magnetic disk 11 as a normal operation. That is, if an ECC error occurs, it performs an off-line error correction or an error recovery. Or, if a reassigned data sector is present, it reads the reassignment destination data sector (S14). Thus, continuity and transfer rate in data transfer can be maintained by reading the reassignment source data sector in response to a predetermined read command.

If a reassigned data sector is present, the HDD 1 according to one embodiment performs a data write operation (including the case that it does not write to the magnetic disk 11 due to an error) to the reassignment source data sector in addition to the reassignment destination data sector. Writing data to the reassignment source data sector improves the accuracy in data to be transferred in the continuous read. The HDD 1 can perform write operations to the reassignment destination data sector and the reassignment source data sector in the same way. In the present specification, the “write operation” includes a correction operation and an error recovery if an error occurs as well as an actual write operation of magnetic data to the magnetic disk 11.

However, the reassignment source data sectors are usually defective sectors having any problem so that there is high probability that a data write cannot be completed to the reassignment source data sector or it takes long time to write data due to an error occurrence, which may impair the performance of the HDD 1. Therefore, the data write operations are preferably different between the reassignment destination sector and the reassignment source data sector. In a preferred example, the HDD 1 performs an error recovery in a different way if an error has occurred.

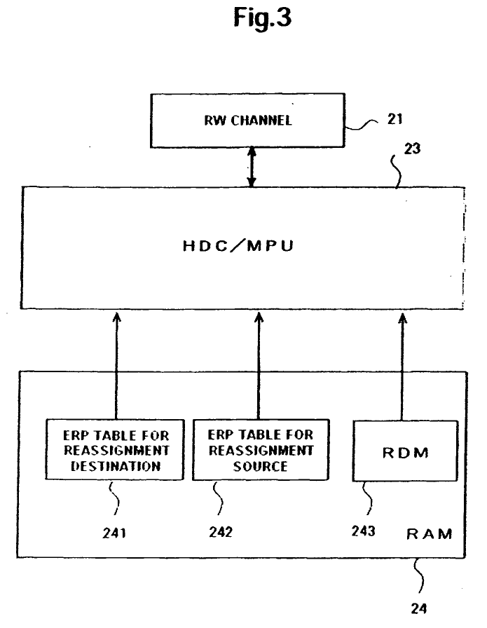

The HDC/MPU 23 controls the error recovery. Specifically, as shown in a block diagram of FIG. 3, the HDC/MPU 23 performs an error recovery referring to an ERP table on the RAM 24. The HDD 1 has an ERP table for reassignment destination 241 for a write to the reassignment destination data sector and an ERP table for reassignment source 242 for a write to the reassignment source data sector. If an error occurs in a write operation to the reassignment destination data sector, the HDC/MPU 23 refers to the ERP table for reassignment destination 241; and if an error occurs in a write operation to the reassignment source data sector, it refers to the ERP table for reassignment source 242.

The ERP tables 241 and 242 contain steps for error recovery recorded therein, particularly such as a retry step of write operation under the same conditions, a retry step with a changed parameter of the RW channel 21, and the like. The HDC/MPU 23 performs the ERP steps sequentially from the ERP step with higher priority until the error recovery or to the final ERP step. In a preferred embodiment, the maximum number of the execution steps in the ERP table for reassignment source 242 is smaller than the maximum number of execution steps in the ERP table for reassignment destination 241.

The maximum number of ERP steps is the number of steps from the beginning to the last ERP steps to be actually carried out. For example, 128 is assigned to the maximum number of execution steps in the ERP table for reassignment destination 241 and 64 is assigned to the number of execution steps in the ERP table for reassignment source table 242. Assigning the smaller number of the execution steps in the ERP table for reassignment source table 242 avoids wasting much time for a write operation to the reassignment source data sector so that the performance degradation is prevented.

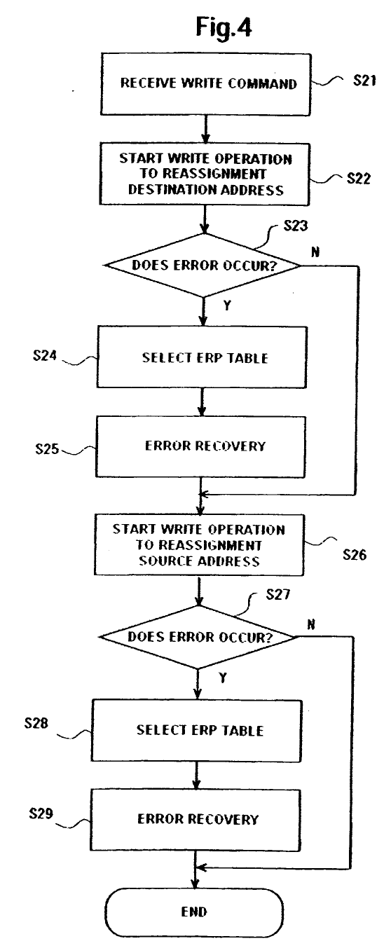

Now referring to a flowchart of FIG. 4, a method for referring to different ERP tables will be described in detail. If the HDC/MPU 23 receives a write command from the host 51 (S21), it starts a data write operation to the designated address. If a reassigned data sector is present in the designated address, the HDC/MPU 23 starts a write operation to the data sector at the reassignment destination address (S22). If an error arises in the write operation to the data sector (Y in S23), the HDC/MPU 23 refers to the ERP table for reassignment destination 241 (S24) to perform an error recovery (S25). If the error has been recovered or any errors do not arise (N in S23) so that the write operation to the data sector can be performed normally, the write operation to the data sector ends. If the error is not recovered by the last ERP step, the HDC/MPU 23 performs normal operations such as a reassignment operation.

The HDC/MPU 23 attempts to write data to the reassignment source address. If the HDC/MPU 23 starts a write operation to the reassignment source address (S26) and an error arises (Y in S27), the HDC/MPU 23 selects the ERP table for reassignment source 242 (S28). If it performs an error recovery in accordance with the ERP table for reassignment source 242 (S29) and completes the error recovery to write data normally, the data write operation to the reassignment source address ends. If the error is not recovered by the last step, the HDC/MPU 23 ends the operation without data write to the reassignment source address. If no errors arise (N in S27), the HDC/MPU 23 writes data normally and ends the data write operation to the reassignment source address.

Since it is permitted even if the data of the reassignment source data sector are not updated, there arises no problem even if the data write operation ends in case that the error has not been recovered. From the view point of the performance, it is preferable that the operation ends at the earliest timing as possible. Smaller number of ERP execution steps and end of the operation without error recovery in case that the error is not recovered improve the accuracy in data and maintain the performance.

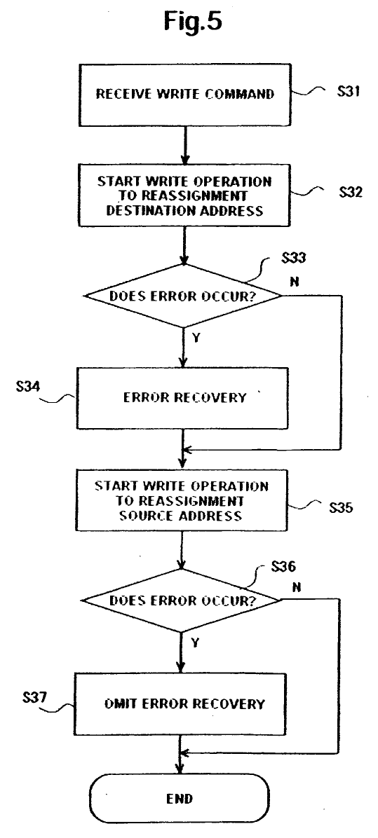

In the above example, if an error arises in the write operation to the reassignment source data sector, an error recovery is performed referring to a table with smaller number of the maximum execution steps than the one in normal. If the priority is placed in the performance, omission of the error recovery can shorten the operation time. Specifically, as shown in the flowchart of FIG. 5, if the HDC/MPU 23 starts a data write operation to the reassignment source address (S35) and an error arises (Y in S36), it ends the operation without error recovery (S37). The other operations are the same as the flowchart of FIG. 4. The omission of the error recovery can make degradation in the performance smaller.

The examples explained referring to FIGS. 4 and 5 always perform a write operation to the reassignment source address in addition to a write operation to the reassignment destination address (including the case that does not actually write) although they are different in the point that the error recovery is performed or not. On the contrary, a data write operation may be performed to the reassignment source address if predetermined conditions have been satisfied. This suppresses degradation in the performance. In a preferable example, the HDC/MPU 23 determines whether or not a write operation to the reassignment source data sector should be performed or not depending on a reason for the reassignment.

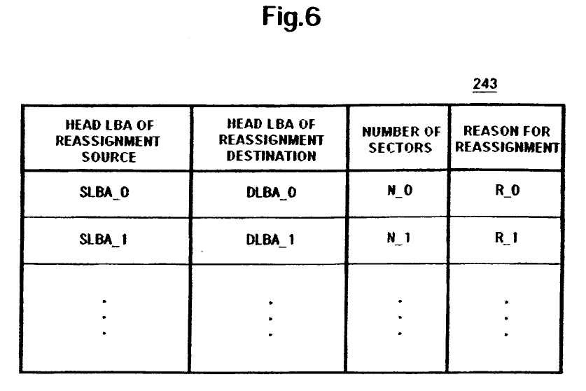

FIG. 6 schematically illustrates registered data in a reassignment defect map (RDM) 243. The HDC/MPU 23 refers to the RDM 243 in accessing the magnetic disk 11 to identify the reassignment destination address of the address designated by the command. In this RDM 243, continuous addresses can be registered as one entry. The RDM 243 contains a head logical block address (LBA) of the reassignment source data sector, a head LBA of the reassignment destination data sector, the number of data sectors, and the reason for reassignment.

The reasons for reassignment are particularly a read error, a write error, a command from the host 51, and the like. The HDC/MPU 23 registers a corresponding address in the RDM 243 if an error cannot be recovered in a read operation (read error) or in a write operation (write error), or in accordance with a command from the host 51. The HDC/MPU 23 refers to the reason for reassignment and determines whether or not it performs a data write operation to the reassignment source address, if the write command designates the reassignment source address.

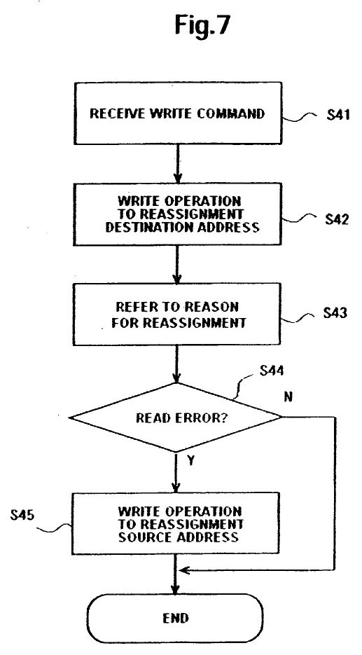

Detailed operation steps will be explained referring to a flowchart of FIG. 7. This example performs a data write operation to the reassignment source address if the reason for reassignment is a read error, and omits the data write operation to the reassignment source address for other reasons. This is because it is more likely to be able to write data to the reassignment source address in a read error than in a write error. If the reason for reassignment is the command, either to perform or not to perform a data write operation may be selected depending on the designs.

If the HDC/MPU 23 receives a write command (S41), it performs a write operation to a reassignment destination address (S42). The HDC/MPU 23 determines the reason for reassignment referring to the RDM 243 (S43). If the reason for reassignment is a read error (Y in S44), the HDC/MPU 23 performs a write operation to the reassignment source address (including the case that an actual write is not made due to an error) (S45). If the reason for reassignment is not a read error (N in S44), the HDC/MPU 23 ends the operations without starting a write operation to the reassignment source address.

The above example determines whether or not the data write operation is necessary to the reassignment source address depending on the reason for reassignment. On the contrary, the way of error recovery may be changed depending on the reason for reassignment. In one example, the HDC/MPU 23 refers to an ERP table containing a large number of registered execution steps in a read error and an ERP table containing a small number of registered execution steps in other errors.

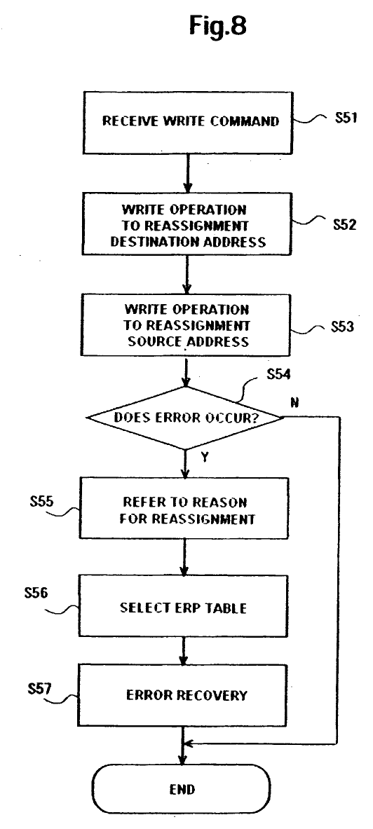

Specifically, as shown in a flowchart of FIG. 8, if the HDC/MPU 23 receives a write command (S51), it performs a write operation to the reassignment destination address (S52). Moreover, the HDC/MPU 23 starts a write operation to the reassignment source address (S53). If an error arises (Y in S54), the HDC/MPU 23 identifies the reason for reassignment referring to the RDM 243 (S55) and selects the ERP table in accordance with the reason (S56). In case of a read error, the HDC/MPU 23 selects a table with a large number of registered execution steps; and in case of other reasons, it selects a table with a small number of registered execution steps. Then, the HDC/MPU 23 executes an error recovery in accordance with the selected ERP table (S57).

In another example, the HDC/MPU 23 determines the necessity of data write operation to the reassignment source address depending on the number of reassigned data sectors in the address designated by the write command. If the number of the reassignment source addresses in the designated address exceeds a reference number, the HDC/MPU 23 performs a data write operation to the reassignment source address. If it does not exceed, it does not perform the operation. The number of data sectors to be counted may be the number of all reassignment source data sectors in the address designated by the command or the maximum number of the continuous data sectors in the address designated by the command.

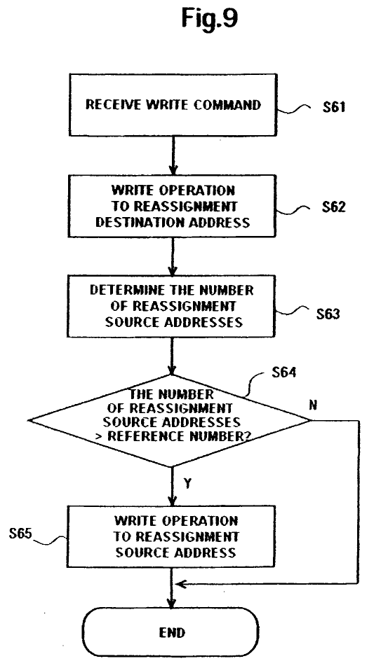

Now referring to a flowchart of FIG. 9, detailed operations will be described. If the HDC/MPU 23 receives a write command (S61), it performs a data write operation to the designated address including the reassignment destination address (S62). The HDC/MPU 23 determines the number of the reassignment source addresses (the number of data sectors) in the designated address, referring to the RDM 233 (S63). If the number of the reassignment source addresses exceeds the reference number (Y in S64), the HDC/MPU 23 performs a data write operation to each of the reassignment source addresses (including the case that the write operation cannot be performed due to an error). If the number of reassignment source addresses is the reference number or less (N in S64), the HDC/MPU 23 ends the operations without performing the data write operation to the reassignment source data sector.

The number of addresses to be compared with the reference number may be the maximum number of continuous sectors or the number of total sectors as described above. In another case, whether or not a write operation is performed to the reassignment source data sector may be determined depending on the kind of the write command. For example, if the write command is a stream command, it may be determined to perform a write operation to the reassignment source data sector.

Based on the number of reassignment source data sectors in the designated address in the write command, the HDC/MPU 23 may change the ERP table in a data write operation to the reassignment source address. It corresponds to changing the criteria in the operation explained referring to FIG. 8 from the reason for reassignment into the number of reassignment source data sectors.

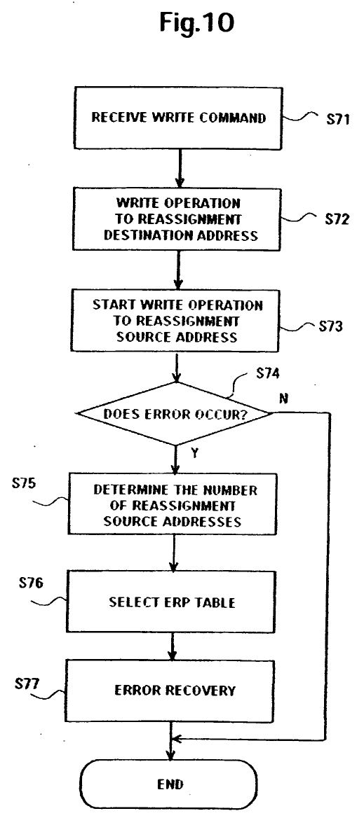

Specifically, as shown in FIG. 10, if an error occurs in a data write operation to the reassignment source address (Y in S74), the HDC/MPU 23 determines the number of reassignment source addresses in the designated address (S75) and selects the ERP table based on the number. For example, two ERP tables are prepared and if the number of reassignment source addresses is less than the reference number, the HDC/MPU 23 uses an ERP table having a smaller number of registered execution steps to perform an error recovery (S76). Depending on the designs, three or more tables may be prepared.

In a read continuous, it may be desirable to select either the reassignment source data sector or the reassignment destination sector depending on predetermined conditions and transfer the selected data to the host 51, instead of reading the reassignment source data sector or reading the reassignment destination sector at all times. This achieves both of accuracy in transferred data and sustainment of transfer rate.

In an example, the HDC/MPU 23 selects either the reassignment source address or the reassignment destination address depending on the number of the reassignment source addresses (number of the data sectors) in the designated address by the read command corresponding to the read continuous. Specifically, if the number of reassignment source addresses in the designated address exceeds the reference number, the HDC/MPU 23 reads the reassignment destination data sector; and if it does not exceed the reference number, the HDC/MPU 23 reads the reassignment source data sector. If the number of reassigned data sectors is large, accessing the reassignment destination achieves both accuracy in data and sufficient transfer rate. The number of the reassignment source addresses to be compared with the reference number may be the total address number or the maximum number of the continuous addresses as in the above-described example.

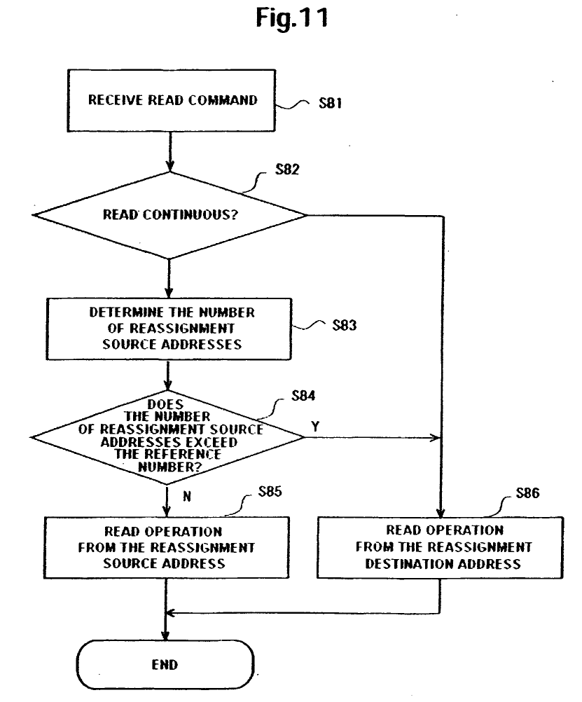

Now referring to FIG. 11, the flow of the above-described continuous read will be explained. If the HDC/MPU 23 receives a read command from the host (S81), it determines whether or not the read command is a command ordering a read continuous (S82). If the received read command is a stream command and the read continuous function has been enabled by a setting command from the host 51 or by the read command (Y in S82), the HDC/MPU 23 determines the number of reassignment source addresses in the designated address in the read command referring to the RDM 234 (S83).

If the number of the reassignment source addresses exceeds the reference number (Y in S84), the HDC/MPU 23 reads the reassignment destination data sector (S85). In this step, it may perform a correction operation of the ECC error or ignore the error. If the number of reassignment source addresses does not exceed the reference number (N in S84), the HDC/MPU 23 reads the reassignment source data sector instead of the reassignment destination and transfers the data to the host 51 (S86). In this step, the HDC/MPU 23 ignores the ECC error.

If the received read command is not a stream read command or the read continuous has been disabled (N in S82), the HDC/MPU 23 retrieves data from the magnetic disk 11 as a normal operation. Namely, if an ECC error occurs, it performs an error correction or an error recovery off-line. If any reassigned data sector is present, it reads the reassignment destination data sector (S85).

As set forth above, embodiments of the present invention have been described by way of example of particular embodiments but are not limited to the above embodiments. A person skilled in the art can easily modify, add, and convert each element in the above embodiments within the scope of the present invention. For example, the control according to one embodiment can be applied to a disk drive device using disks other than magnetic disks. The components in each of the above examples may be combined or may be used separately. For example, the selection of the reassignment source address or reassignment destination address may be performed independent from the ECC error handling.

What is claimed is:

1. A method for accessing a disk in a disk drive device, the method comprising:
performing a data write operation to a reassignment source address and a reassignment destination address corresponding to the reassignment source address in response to a write command to the reassignment source address; and
sending data at the reassignment destination address in response to a normal read command and sending data at the reassignment source address in response to a predetermined read command.

2. A method according to claim 1, wherein
if an error occurs in the data write operation to the reassignment source address, the method omits an error recovery and ends the data write operation to the reassignment source address.

3. The method according to claim 1, wherein
the maximum number of steps for an error recovery corresponding to the data write operation to the reassignment source address is smaller than the maximum number of steps for an error recovery corresponding to the data write operation to the reassignment destination address.

4. The method according to claim 1, wherein
the method changes the data write operation to the reassignment source address depending on a reason for reassignment of the reassignment source address.

5. The method according to claim 4, wherein
if the reason for reassignment is a write error, the method omits an error recovery in the data write operation to the reassignment source address or sets the maximum number of steps for the error recovery to be smaller than the maximum number of steps in a case that the reason for reassignment is a read error.

6. The method according to claim 1, further comprising:
determining whether or not the data write operation to the reassignment source address should be executed depending on the kind of the write command.

7. The method according to claim 1, wherein
the write command to the reassignment source address includes a plurality of addresses; and
the method determines whether or not the data write operation to the reassignment source address should be executed or changes the maximum number of steps for an error recovery depending on the number of the reassignment source addresses included in the plurality of addresses.

8. A disk drive device comprising:
a head for accessing a disk;
a moving mechanism for moving the head above the disk; and
a controller for sending data at a reassignment destination address retrieved with the head in response to a normal read command and sending data at a reassignment source address retrieved with the head in response to a predetermined read command, and performing data write operations to the reassignment destination address corresponding to the reassignment source address and the reassignment source address in response to a write command to the reassignment source address.

9. The disk drive device according to claim 8, wherein
if an error occurs in the data write operation to the reassignment source address, the controller omits an error recovery and ends the data write operation to the reassignment source address.

10. The disk drive device according to claim 8, wherein
the maximum number of steps for an error recovery corresponding to the data write operation to the reassignment source address is smaller than the maximum number of steps for an error recovery corresponding to the data write operation to the reassignment destination address.

11. The disk drive device according to claim 8, wherein
the controller changes the data write operation to the reassignment source address depending on a reason for reassignment of the reassignment source address.

12. The disk drive device according to claim 11, wherein
if the reason for reassignment is a write error, the controller omits an error recovery in the data write operation to the reassignment source address or sets the maximum number of steps for the error recovery to be smaller than the maximum number of steps in a case that the reason for reassignment is a read error.

13. The disk drive device according to claim 8, wherein
the controller determines whether or not the data write operation to the reassignment source address should be executed depending on the kind of the write command to the reassignment source address.

14. The disk drive device according to claim 8, wherein
the write command to the reassignment source address includes a plurality of addresses; and
the controller determines whether or not the data write operation to the reassignment source address should be executed or changes the maximum number of steps for an error recovery depending on the number of the reassignment source addresses included in the plurality of addresses.

15. A disk drive device comprising:
a head for accessing a disk;
a moving mechanism for moving the head; and
a controller for controlling the moving mechanism; wherein
the controller retrieves data at a reassignment destination address using the head in response to a normal read command, and further determines whether to retrieve data at a reassignment source address or to retrieve data at a reassignment destination address based on the number of reassignment source addresses included in the addresses designated by a predetermined read command.

16. The disk drive device according to claim 15, wherein
the number of reassignment source addresses is the maximum number of continuous reassignment source addresses in the designated addresses; and
the controller retrieves data at the reassignment destination address using the head if the maximum number of the continuous reassignment source addresses exceeds a reference number.

17. The disk drive device according to claim 15, wherein
the number of reassignment source addresses is a total number of the reassignment source addresses included in the designated addresses; and
the controller retrieves data at the reassignment destination address using the head if the total number exceeds a reference number.
